(19) United States
(12) Patent Application Publication
(10) Pub. No.: US 2008/0185764 A1
(43) Pub. Date: Aug. 7, 2008

(54) SHEET PROCESSING APPARATUS

(75) Inventor: Shouichi Dobashi, Izunokuni-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: TOSHIBA TEC KABUSHIKI KAISHA, Tokyo (JP)

(21) Appl. No.: 11/670,073

(22) Filed: Feb. 1, 2007

(51) Int. Cl. B41L 43/08; B41L 43/12

(52) U.S. Cl. 270/37; 270/32

(57) ABSTRACT

A sheet processing apparatus of the present invention includes a folding mechanism that includes a folding roller pair disposed along a conveyance path of sheets, the folding mechanism pushing the sheets from a direction orthogonal to a conveyance direction into a nip portion between the pair of folding rollers and rotating the folding roller pair to fold the sheets; and a discharge roller pair for discharging, into a paper discharge tray, the sheets that have been folded by the rotation of the folding roller pair, wherein each roller of the folding roller pair has a multilayer structure including a first layer roller and a second layer roller disposed on the outer periphery of the first roller, with the hardness of the first layer roller being higher than the hardness of the second layer roller.

### BACKGROUND OF THE INVENTION

1. Field of the Invention

The present invention relates to a sheet processing apparatus that post-processes sheets discharged from an image forming apparatus such as a copier, a printer, or a multi-function peripheral (MFP).

2. Description of the Related Art

In recent years, among image forming apparatus, there are image forming apparatus where a sheet post-processing apparatus is disposed adjacent to the image forming apparatus body in order to perform post-processing such as sorting sheets after image formation and stapling sheets. Further, there are also sheet post-processing apparatus that fold sheet bundles in two and discharge the sheet bundles.

When a sheet bundle is to be folded, ordinarily the center portion of the sheet bundle is pushed between a pair of folding rollers, and the folding roller pair is rotated to fold the sheet bundle. However, there has been the drawback that folding cannot be performed accurately when the sheet bundle is thick.

In Japanese Patent Application Publication No. 2006-208659, there is description in regard to a pressure roller in an image forming apparatus. The pressure roller forms a pair with a heat roller and causes a toner image that has been transferred to a sheet to be fixed to the sheet.

In this publication, an example is described where an elastic rubber layer is disposed on the outer periphery of a shaft of the pressure roller, and the outer periphery of the elastic rubber layer is covered with a fluororesin tube. By disposing the elastic rubber layer, slippage during conveyance of the sheet is reduced and fixing performance is improved.

Further, in Japanese Patent Application Publication No. 2002-293447, there is description in regard to a brochure conveying device. In this publication, an example is described where the brochure conveying device includes a drive roller and a pinch roller for conveying a brochure such as a passbook and where the hardness of the pinch roller is set in the range of A15/S to A45/S.

Moreover, in Japanese Patent Application Publication No. 2-138043, there is description in regard to conveyance rollers in a laser printer or a copier. The conveyance rollers convey sheets, and in this publication, an example is described where the hardness of one roller of a pair of conveyance rollers is raised and where the hardness of the other roller of the pair of conveyance rollers is lowered to make conveyance of the sheets smooth.

However, none of these examples is a roller for folding sheets, and it cannot be said that they have roller structures suited for folding sheets.

The invention provides a sheet processing apparatus that is disposed with a finisher including a sheet folding mechanism and can accurately perform folding of sheets.

### DESCRIPTION OF THE DRAWING

FIG. 1 is a schematic configural diagram showing a sheet processing apparatus pertaining to an embodiment of the invention.

FIG. 2 is an enlarged configural diagram showing the configuration of relevant portions of the sheet processing apparatus of the invention.

FIG. 3 is an explanatory diagram describing operation of the folding of sheets in the sheet processing apparatus of the invention.

FIG. 4 is a perspective view showing a folding roller device of the invention.

FIG. 5 is a side view showing the folding roller device of the invention.

FIG. 6A and FIG. 6B are explanatory diagrams describing operation of the folding of sheets using the folding roller device of the invention.

FIG. 7 is a block diagram showing a control system of the sheet processing apparatus of the invention.

### DETAILED DESCRIPTION OF THE INVENTION

Throughout this description, the embodiments and examples shown should be considered as exemplars, rather than limitations on the apparatus of the invention.

An embodiment of this invention will be described in detail below with reference to the drawings. It will be noted that the same places in the drawings will be described adding the same reference numerals.

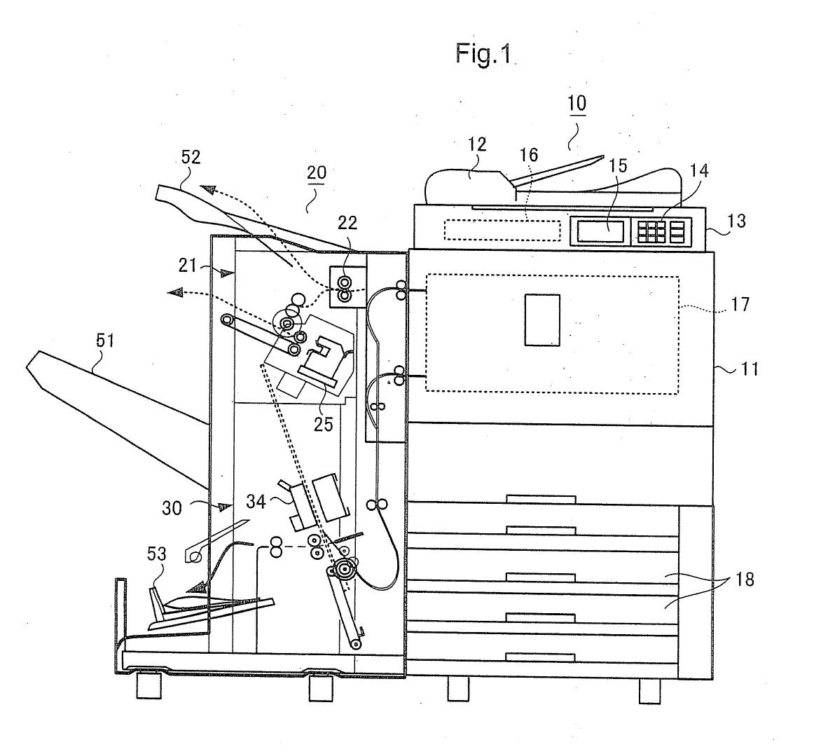

FIG. 1 is a configural diagram showing an example of a sheet processing apparatus of the invention. In FIG. 1, 10 is a image forming apparatus and is an MFP (Multi-Function Peripherals), printer, or copier, for example. A sheet processing apparatus 20 is disposed adjacent to the image forming apparatus 10. Sheets on which images have been formed by the image forming apparatus 10 are conveyed to the sheet processing apparatus 20.

The sheet processing apparatus 20 performs post-processing of sheets supplied from the image forming apparatus 10, such as sorting and stapling. The sheet processing apparatus 20 also folds sheets in two and discharges the sheets as necessary. Because the sheet processing apparatus 20 is usually called a “finisher”, there are instances in the following description where the sheet processing apparatus 20 is called the “finisher 20”.

In FIG. 1, there is a document platen (not shown) on the upper portion of a body 11 of the image forming apparatus 10, and an automatic document feeder (ADF) 12 is disposed on the document platen such that the ADF 12 may be freely opened and closed. Moreover, an operation panel 13 is disposed on the upper portion of the body 11. The operation panel 13 includes an operation unit 14 comprising various kinds of keys and a touch panel display unit 15.

The body 11 includes inside a scanner unit 16 and a printer unit 17, and plural cassettes 18 in which sheets of various sizes are stored are disposed in the lower portion of the body 11. The scanner unit 16 reads documents fed by the ADF 12 or documents placed on the document platen.

Further, the printer unit 17 includes photoconductive drums and lasers, and scans and exposes the surfaces of the photoconductive drums with laser beams from the lasers to create electrostatic latent images on the photoconductive drums. Charging devices, developing devices, and transfer devices are disposed around the photoconductive drums, and the electrostatic latent images on the photoconductive drums are developed by the developing devices so that toner images are formed on the photoconductive drums. The toner images are transferred to a sheet by the transfer devices. The configuration of the printer 17 is not limited to the above example; there are various kinds.

The finisher 20 includes a stapling mechanism 21 that staples a sheet bundle, a saddle stitcher 30 that folds sheets, a paper discharge tray 51, a fixed tray 52, and a paper discharge tray 53. The paper discharge tray 51 is movable and receives sheet bundles that have been stapled. Further, the stapling mechanism 21 is disposed with an aligning device that aligns the conveyed sheets in the width direction, so that the sheets can also be sorted and discharged utilizing this aligning device.

It will be noted that, when post-processing such as stapling is not to be performed, the sheets conveyed from the image forming apparatus 10 are discharged into the paper discharge tray 51 or the fixed tray 52 as they are without being processed at all.

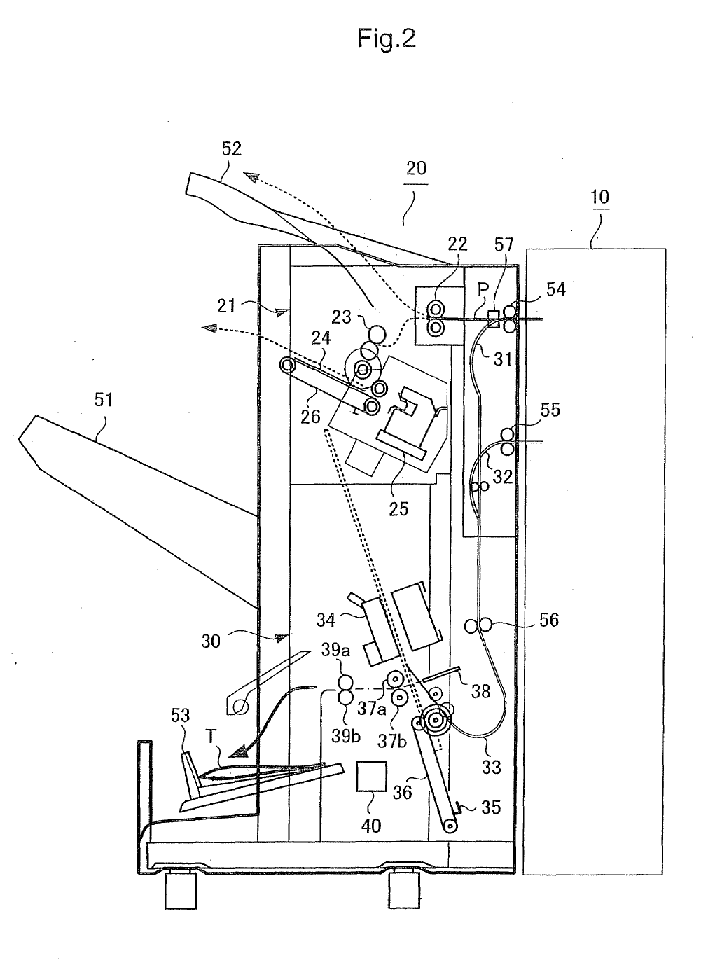

An enlarged view of the configuration of the finisher 20 is shown in FIG. 2. First, the stapling mechanism 21 of the finisher 20 will be briefly described. Sheets P conveyed from the image forming apparatus 10 are received by an inlet roller 22 disposed in the vicinity of a carry-in opening in the finisher 20. A paper feed roller 23 is disposed downstream of the inlet roller 22, and the sheets P received by the inlet roller 22 are stacked in a processing tray 24 via the paper feed roller 23 and the like.

The sheets stacked in the processing tray 24 are guided to a stapler 25 to be stapled. Further, a conveyor belt 26 is disposed in order to convey sheets P that have been sorted or stapled to the paper discharge tray 51.

The sheets P conveyed by the conveyor belt 26 are discharged to the paper discharge tray 51, and the paper discharge tray 51 is raised or lowered by a drive unit (not shown) to receive the sheets P.

Further, there are also instances where the sheets P are to be discharged into the paper discharge tray 51 without being stapled. In such instances, the sheets P are discharged without being dropped into the processing tray 24. Further, sheets P that do not need to be post-processed can also be discharged into the fixed tray 52. A conveyance path is disposed in order to guide the sheets P to the fixed tray 52, but illustration thereof is omitted.

Next, the configuration of the saddle stitcher 30 will be described. The saddle stitcher 30 is a device that bundles a plurality of the sheets that have been supplied from the image forming apparatus 10 and folds the sheet bundle in two.

The sheets P conveyed from the image forming apparatus 10 are conveyed via a paper path 31 or 32, are further conveyed in the direction of a stapler 34 via a paper path 33, and received by a stacking tray 35. The sheets P that are conveyed are successively accumulated in the stacking tray 35 to become a sheet bundle.

A sheet bundle T in the stacking tray 35 is conveyed in the direction of the stapler 34 by a guide belt 36, the guide 36 belt temporarily stops when the center portion of the sheet bundle T reaches the stapler 34, and the center portion of the sheet bundle T is stapled.

The sheet bundle T stapled by the stapler 34 is lowered by the guide belt 36 and stopped at a position where the center portion of the sheet bundle T reaches a nip point between a folding roller pair 37a and 37b. A blade 38 is disposed at a position facing the folding roller pair 37a and 37b.

The blade 38 pushes the center portion of the sheet bundle T into the nip point between the folding roller pair 37a and 37b and pushes the sheet bundle T between the folding rollers 37a and 37b. Thereafter, the folding roller pair 37a and 37b folds the sheet bundle T and rotates while nipping the sheet bundle T to fold the sheet bundle T in two. The sheet bundle T that has been folded in two is conveyed by a discharge roller pair 39a and 39b and discharged into the paper discharge tray 53.

Further, a drive motor 40 is disposed in order to drive the folding rollers 37a and 37b and the discharge roller pair 39a and 39b to rotate.

It will be noted that guide rollers 54, 55, and 56 are disposed in order to guide the sheets P supplied from the image forming apparatus 10 along the paper paths 31, 32, and 33. Further, a gate 57 is disposed in the outlet of the guide roller 54 in order to switch between conveying the sheets P supplied from the image forming apparatus 10 to the stapling mechanism 21 or to the saddle stitcher 30.

When the sheets are not to be folded, the gate 57 conveys the sheets P discharged from the image forming apparatus 10 to the roller 22 of the stapling mechanism 21. When the sheets are to be folded, the gate 57 conveys the sheets P to the saddle stitcher 30.

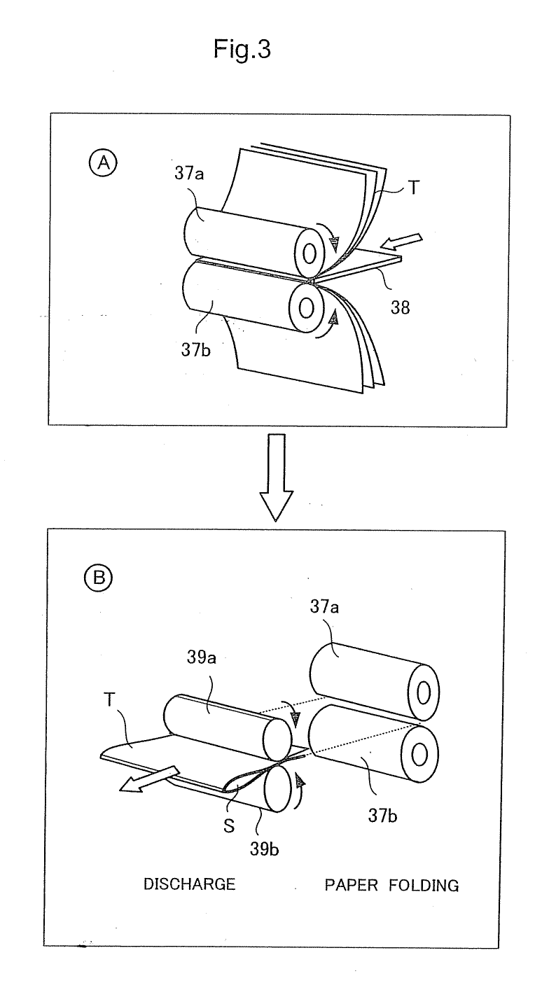

FIG. 3 is a flow diagram schematically describing operation of the saddle stitcher 30. The sheets P discharged from the image forming apparatus 10 are conveyed via the paper path 33 and received by the stacking tray 35 before being sent to the stapler 34, and the sequentially conveyed sheets P are accumulated in the stacking tray 35 and aligned as the sheet bundle T.

Next, the sheet bundle T is conveyed to the stapler 34 by the guide belt 36, and when the center portion of the sheet bundle T reaches the stapler 34, the stapler 34 staples the center portion of the sheet bundle T. Thereafter, the stapled sheet bundle T is lowered by the guide belt 36.

When the center portion of the sheet bundle T reaches the nip point between the folding roller pair 37a and 37b, as shown in A of FIG. 3, the blade 38 pushes the center portion of the sheet bundle T into the nip point between the folding roller pair 37a and 37b and pushes it between the folding rollers 37a and 37b. Then, the roller pair 37a and 37b rotates so as to take in the sheet bundle T, whereby the sheet bundle T is folded and discharged.

The sheet bundle T that has been folded in two is conveyed by the discharge roller pair 39a and 39b as shown in B of FIG. 3 and discharged into the paper discharge tray 53.

Incidentally, when the thickness of the sheet bundle T is thick, the sheet bundle T cannot be sufficiently folded and tries to return to normal due to the restoring force of the sheet bundle. For this reason, as shown in B of FIG. 3, sometimes a swell S occurs in the sheet bundle T discharged from the discharge roller pair 39a and 39b, so that the sheet bundle T expands when it is discharged into the paper discharge tray 53. The swell S also occurs when the sheet bundle T is discharged from the folding rollers 37a and 37b.

The invention is configured to be able to accurately perform folding by improving the folding rollers 37a and 37b.

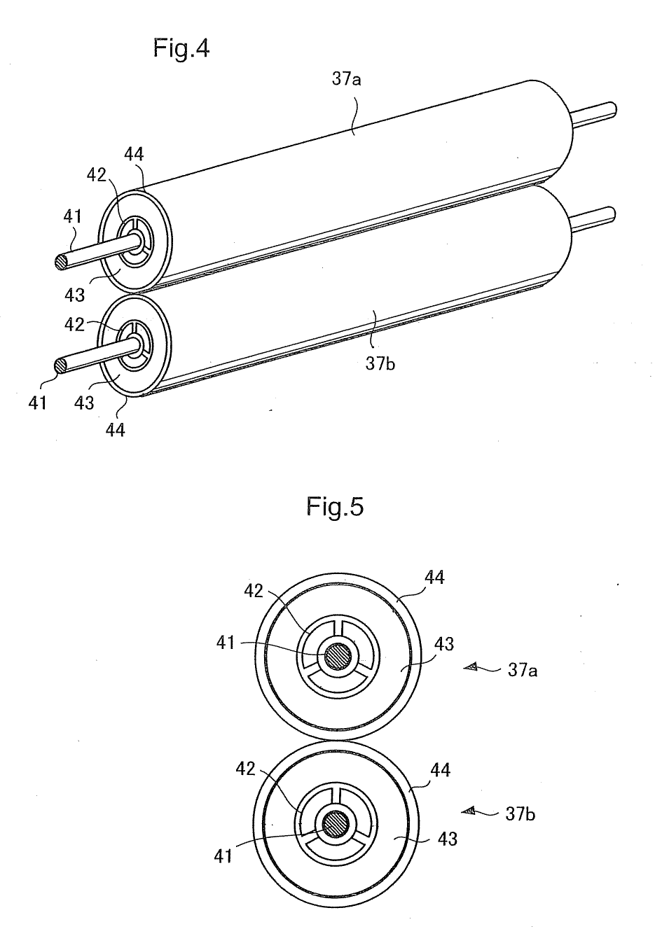

FIG. 4 is a perspective view showing a folding roller device used in the sheet processing apparatus of the invention. Further, FIG. 5 is a side view of the folding roller device. The folding roller device comprises the pair of folding rollers 37a and 37b.

The folding rollers 37a and 37b have the same structure, and a core 2 comprising a metal or a mold is disposed on the outer periphery of a shaft 41 serving as a rotational center. Moreover, rollers 43 and 44 of a two-layer structure whose hardnesses are different are disposed on the outer periphery of the core 42.

The rollers 43 and 44 of the two-layer structure have different hardnesses, with the hardness of the inner peripheral roller 43 being high and the hardness of the outer peripheral roller 44 being lower than that of the inner peripheral roller 43. The rollers 43 and 44 comprises, for example, rubber materials whose friction count is high, with the inner peripheral roller 43 comprising a hard rubber and the outer peripheral roller 44 comprising a soft rubber.

The rollers 43 and 44 are biased in the direction in which they contact each other, and the distance between the rollers 43 and 44 is adjustable in accordance with the thickness of the sheet bundle T passing between the rollers 43 and 44.

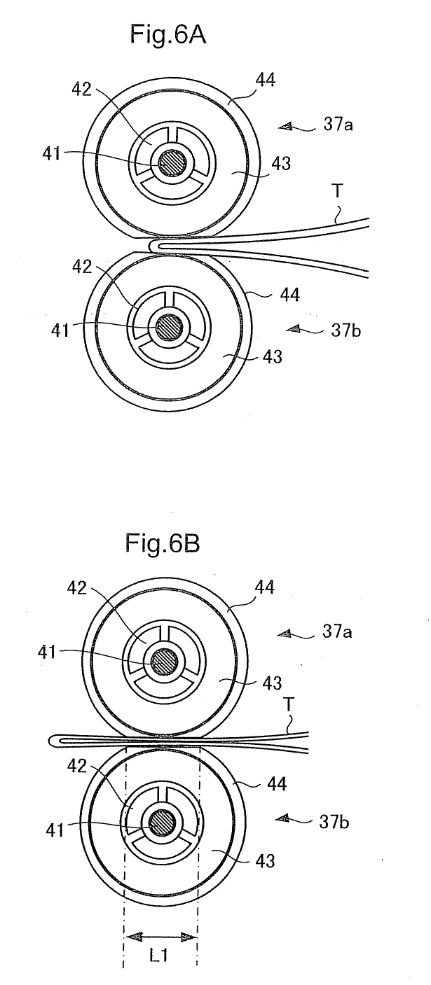

FIG. 6A and FIG. 6B are explanatory diagrams describing the folding of sheets by the folding rollers 37a and 37b of the invention.

FIG. 6A shows a state where the folding line point of the sheet bundle T is positioned in the nip portion between the folding rollers 37a and 37b. In this state, the portions of the outer peripheral rollers 44 that contact the sheet bundle T are compressed because the outer peripheral rollers 44 are soft, and the sheet bundle T is folded by the inner peripheral rollers 43 of the folding rollers 37a and 37b. The inner peripheral rollers 43 can fold the sheet bundle T with strong force because they contact in a state where they substantially point-contact via the sheet bundle T and are hard.

FIG. 6B shows a state where the folding line point of the sheet bundle T has come out of the folding rollers 37a and 37b and the sheet bundle T is to be discharged. At this time, the portions of the outer peripheral rollers 44 that contact the sheet bundle T are compressed because the outer peripheral rollers 44 are soft, and the outer peripheral rollers 44 are in a state where they surface-contact the sheet bundle T. Consequently, during a period corresponding to a width L1 of surface contact, the sheet bundle T is nipped by the folding rollers 37a and 37b so that swelling of the sheet bundle T after folding can be controlled.

In this manner, because the sheet bundle T is nipped by the hard rollers 43 so that folding lines are imparted and the sheet bundle T is nipped for a long period (width L1) by the soft rollers 44, the restoring force of the sheet bundle T can be reduced and the sheet bundle T can be accurately folded.

It will be noted that, when the thickness of the outer peripheral rollers 44 is too thick, the rollers 44 end up absorbing the force with which the sheet bundle T is folded by the inner peripheral rollers 43, so it is preferable for the thickness of the outer peripheral rollers 44 to be thinner than the thickness of the inner peripheral rollers 43.

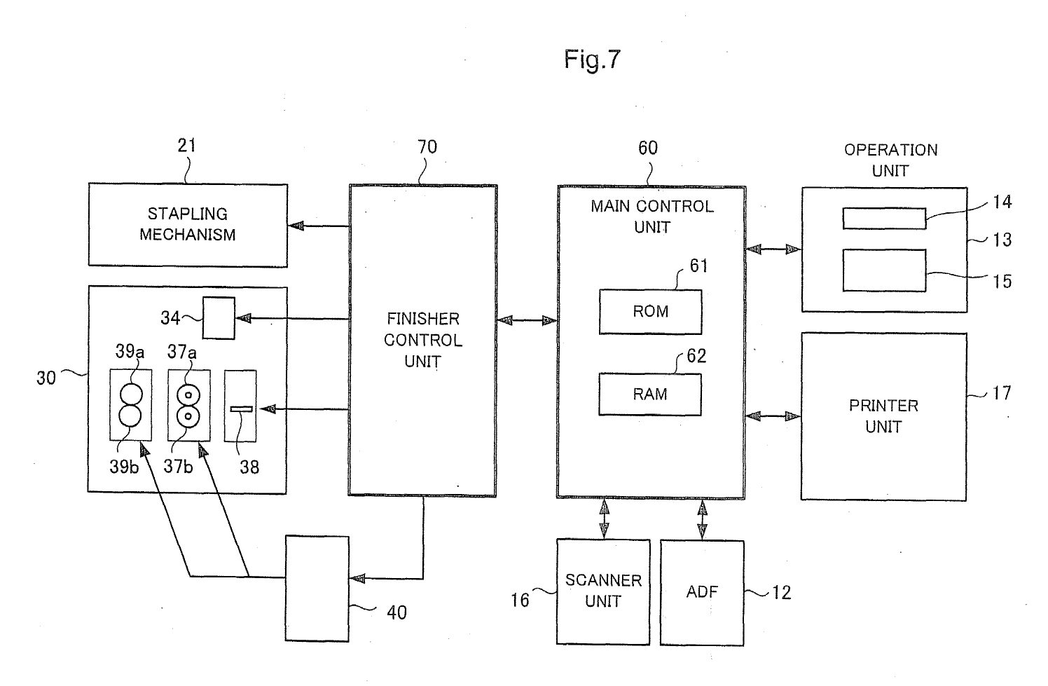

Next, the configuration of a control system of the sheet processing apparatus of the invention will be described with reference to the block diagram of FIG. 7.

In FIG. 7, a main control unit 60 includes a CPU, a ROM 61, and a RAM 62 and controls the image forming apparatus 10 in accordance with a control program stored in the ROM 61. The main control unit 60 controls operation of the ADF 12, the scanner unit 16, and the printer unit 17 in response to operation from the operation panel 13. The RAM 62 temporarily saves control data and is used in computational work during control.

The operation panel 13 includes the operation unit 14 comprising plural keys and the display unit 15 that doubles as a touch panel, so that various kinds of instructions for image formation can be delivered. For example, instructions relating to the number of sheets of copies and the number sets of copies are given using the operation unit 14, and instructions relating to sheet size, sheet type and stapling, and instructions relating to sheet folding, are given using the touch panel of the display unit 15.

Further, a finisher control unit 70 controls the stapling mechanism 21 and the saddle stitcher 30 of the finisher 20. The finisher control unit 70 is connected to the main control unit 60 and transmits information with the main control unit 60, so that the image forming apparatus 10 and the finisher 20 operate cooperatively.

As the control of the stapling mechanism 21 by the finisher control unit 70, there are implementation of stapling by the stapler 25, conveyance of the sheets P to the stapler 25, and discharging of the sheets after being stapled.

Further, as the control of the saddle stitcher 30 by the finisher control unit 70, there are conveyance of the sheets P via the paper path 33, movement and positioning of the sheet bundle T by the guide belt 36, implementation of stapling by the stapler 34, and pushing by the folding blade 38. Moreover, the drive motor 40 is controlled in order to control the rotation of the folding rollers 37a and 37b and the discharge rollers 39a and 39b.

The folding rollers 37a and 37b and the discharge rollers 39a and 39b are conjunctively rotated by the drive motor 40 to fold and discharge the sheet bundle T.

It will be noted that folding of the sheets can be more effectively executed as a result of the finisher control unit 70 controlling the rotational speed of the motor 40.

For example, when the number of sheets in the sheet bundle T is small, a folding line can be imparted to the sheet bundle T relatively easily even when the folding roller pair 37a and 37b is rotated at a high speed. Consequently, when the number of sheets to be folded is smaller than a predetermined number of sheets, the drive motor 40 may be rotated at a high speed, and when the number of sheets is larger than a predetermined number of sheets, the drive motor 40 may be rotated at a low speed to perform sheet folding. Thus, the speed of folding can be increased.

Further, when the number of sheets is smaller than a predetermined number of sheets, the discharge rollers 39a and 39b may be similarly rotated at a high speed, and when the number of sheets is larger than a predetermined number of sheets, the discharge rollers 39a and 39b may be rotated at a low speed, so that the discharge rollers 39a and 39b can smoothly discharge the sheets in conjunction with the folding roller pair 37a and 37b.

As methods of determining the number of sheets, there is a method that utilizes information relating to a number of sheets that a user has inputted via the operation panel 13, and a method that uses a sensor to detect the sheets passing through the paper path 33 and count the number of sheets that have passed.

As described above, according to the invention, sheets can be accurately folded by configuring the folding rollers 37a and 37b to have a hard and soft two-layer structure.

It will be noted that the invention is not limited to the above description and that various modifications are possible in a range that does not depart from the scope of the claims. For example, the first and second rollers 43 and 44 may also comprise materials other than rubber materials.

Although exemplary embodiments of the invention have been shown and described, it will be apparent to those having ordinary skill in the art that a number of changes, modifications, or alterations to the invention as described herein may be made, none of which depart from the spirit of the invention. All such changes, modifications, and alterations should therefore be seen as within the scope of the invention.

What is claimed is:

1. A sheet processing apparatus comprising:
a folding mechanism that includes a folding roller pair disposed along a conveyance path of sheets, the folding mechanism pushing the sheets from a direction orthogonal to a conveyance direction into a nip portion between the pair of folding rollers and rotating the folding roller pair to fold the sheets; and
a discharge roller pair for discharging, into a paper discharge tray, the sheets that have been folded by the rotation of the folding roller pair,
wherein each roller of the folding roller pair has a multilayer structure including a first layer roller and a second layer roller that is disposed on the outer periphery of the first roller and contacts the sheets, with the hardness of the first layer roller being higher than the hardness of the second layer roller.

2. A sheet processing apparatus according to claim 1, wherein the first layer roller comprises a hard rubber, and the second layer roller comprises a soft rubber whose hardness is lower than that of the first layer roller.

3. A sheet processing apparatus that processes sheets supplied from an image forming apparatus, the sheet processing apparatus comprising;
a folding roller pair disposed along a conveyance path of the sheets supplied from the image forming apparatus;
a blade that is disposed facing the folding roller pair and pushes the sheets from a direction orthogonal to a conveyance direction into a nip portion between the pair of folding rollers;
a discharge roller pair for discharging, into a paper discharge tray, the sheets that have been folded by the rotation of the folding roller pair; and
a control unit configured to control the rotation of the folding roller pair and the discharge roller pair,
wherein each roller of the folding roller pair has a multilayer structure including a first layer roller and a second layer roller that is disposed on the outer periphery of the first roller and contacts the sheets, with the hardness of the first layer roller being higher than the hardness of the second layer roller.

4. A sheet processing apparatus according to claim 3, wherein the control unit changes the rotational speed of the folding roller pair in accordance with the number of the sheets to be folded and controls the rotation of the folding roller pair at a lower speed as the number of the sheets becomes larger.

5. A sheet processing apparatus according to claim 4, wherein the control unit rotates the folding roller pair at a first speed when the number of the sheets is larger than a predetermined number and rotates the folding roller pair at a speed that is faster than the first speed when the number of the sheets is smaller than a predetermined number of sheets.

6. A sheet processing apparatus according to claim 3, wherein the control unit controls the rotational speed of the discharge roller pair in conjunction with the rotational speed of the folding roller pair.

7. A sheet processing apparatus according to claim 3, further comprising a stapler that creates a bundle of a plurality of sheets conveyed from the image forming apparatus and staples the bundle of sheets, wherein the bundle of the sheets that have been stapled is folded by the folding roller pair.

8. A folding roller device for folding sheets, comprising:
a pair of rotatable cylindrical folding rollers, wherein each roller of the pair of folding rollers has a multilayer structure including a first layer roller and a second layer roller that is disposed on the outer periphery of the first roller and contacts the sheets, with the hardness of the first layer roller being higher than the hardness of the second layer roller.

9. A folding roller device according to claim 8, wherein the first layer roller comprises a hard rubber, and the second layer roller comprises a soft rubber whose hardness is lower than that of the first layer roller.

10. A folding roller device according to claim 8, wherein each roller of the pair of folding rollers includes a shaft, a core member disposed on the outer periphery of the shaft, the first layer roller disposed on the outer periphery of the core member, and the second layer roller disposed on the outer periphery of the first layer roller.
